(19) United States
(12) Patent Application Publication
(10) Pub. No.: US 2010/0225928 A1
(43) Pub. Date: Sep. 9, 2010

(54) DEVICE FOR MEASURING STRUCTURES OF AN OBJECT

(75) Inventor: Richard Thelen, Karlsruhe (DE)

Correspondence Address: DARBY & DARBY P.C., P.O. BOX 770, Church Street Station, New York, NY, 10008-0770, US

(73) Assignee: Forschungszentrum Karlsruhe GmbH, Karlsruhe (DE)

(21) Appl. No.: 12/161,491

(22) PCT Filed: Dec. 20, 2006
(86) PCT No.: PCT/EP2006/012280

§ 371 Date: Jul. 18, 2008

(30) Foreign Application Priority Data
Jan. 19, 2006 (DE) 10 2006 002 619.5

(51) Int. Cl. G01B 11/24

(52) U.S. Cl. 356/601

(57) ABSTRACT

A device for measuring structures of an object. The device includes a probe element extending from a probe extension, an optical sensor for capturing an image of the probe element on a sensor field, an evaluation unit configured to compute the structures based on a position of the optical sensor relative to a coordinate system of a coordinate measuring machine and from a position of the probe element measured by the optical sensor. The device also includes a lens disposed on the probe extension between the optical sensor and the probe element.

### CROSS REFERENCE TO PRIOR APPLICATIONS

This application is a U.S. National Phase application under 35 U.S.C. §371 of International Application No. PCT/EP2006/012280, filed on Dec. 20, 2006 and claims benefit to German Patent Application No. DE 10 2006 002 619.5, filed on Jan. 19, 2006. The International Application was published in German on Jul. 26, 2007 as WO 2007/082581 A1 under PCT Article 21(2).

### FIELD

The present invention relates to a device for measuring structures of an object.

### BACKGROUND

EP 0 988 505 B1 describes a device for measuring structures of an object using a probe element which extends from a probe extension, an optical sensor for capturing an image of the probe element on a sensor field, and an evaluation unit capable of computing the structures from the position of the optical sensor relative to the coordinate system of a coordinate measuring machine and from the position of the probe element measured by the optical sensor.

Another device for measuring structures of an object is described in DE 298 24 806 U1. The device has a probe element which extends from a probe extension and is designed as a probe disk or probe tip.

DE 26 15 097 A1 describes an optical fiber having a largely hemispherical lens fused onto the plane end face thereof.

### SUMMARY OF THE INVENTION

An aspect of the present invention to provide a device for measuring structures of an object that will allow the precise position or motion sensing, for example, in the context of small probe elements having dimensions of 1 to 10 micrometers.

In an embodiment, the present invention provides a device for measuring structures of an object. The device includes a probe element extending from a probe extension, an optical sensor for capturing an image of the probe element on a sensor field, an evaluation unit configured to compute the structures based on a position of the optical sensor relative to a coordinate system of a coordinate measuring machine and from a position of the probe element measured by the optical sensor, and a lens disposed on the probe extension between the optical sensor and the probe element.

### BRIEF DESCRIPTION OF THE DRAWINGS

The present invention is described in greater detail below on the basis of embodiments and of the figures cited below. The following is shown:

FIG. 1A—schematic representation of a prior art device (on the left) and of a device according to the present invention (on the right), including an image of the probe element imaged on the sensor field;

FIG. 1B—a lens assembled from two symmetrical parts, as well as the probe extension enclosed within said lens;

FIG. 2—a probe extension including a holding fixture, lens and probe element;

FIG. 3—an interrupted probe extension, including a holding fixture, connections, supplementary elements, a rigid lens, and a probe element;

FIG. 4A—a device having connections provided with bearings so that the lens can be moved;

FIG. 4B—a device having connections which are provided with a slotted lever that imparts rotation to the lens about a horizontal axis through the center thereof;

FIG. 5—a device having piezorods with a fixed optical axis; and

FIG. 6—a device having piezorods in a tripod configuration with a movable optical axis.

### DETAILED DESCRIPTION OF THE INVENTION

In an embodiment, the device in accordance with the present invention is used for measuring structures of an object, such as the side wall of a microstructured component.

The device in accordance with the present invention can be equipped with a probe element. This may be a sphere, as described in EP 0 988 505 B1, or a disk, as described in DE 298 24 806 U1, whose respective diameter is known and whose optical image of the periphery is used in its entirety or in part to capture a point on a contacted side wall of the object and to transmit the same into the plane of sight of an optical sensor, such as a camera, for recording an image of the probe element on a sensor field, to ultimately implement a coordinate transformation to determine the absolute point of contact between the probe element and the object.

The probe element can be permanently or detachably connected to a probe extension. The probe extension can be flexible as described in EP 0 988 505 B1. This can be beneficial when very small probe elements having dimensions of 1-10 μm are used. The probe extension can also be designed as a rigid shaft as in the case of touch trigger probes. In the latter case, the need for utilizing the flexible quality of the shaft can be eliminated while retaining the advantages of an optical imaging of the probe element and of the wall of the object when approached. Thus, from a control which interrupts the travel of the probe tip upon its deflection, one derives a system for approaching the wall of the object in a controlled process. This can be beneficial for sensitive or particularly light objects which are otherwise displaced or are only measurable in a destructive process.

One or more lenses can be affixed to or around the probe extension. The distance of the lens to the probe element and to the optical sensor can be selected so that the image of the probe element magnified by the lens is formed on the sensor. The lens between the probe element and the sensor can thereby be attached to the probe extension.

The lens or the lens system can be located outside of the focus of the optical sensor and can be mounted approximately radially symmetrically to the probe extension.

The lens shape can be selected so that the radius of curvature of the lens side facing the probe element is greater than that of the lens side facing away from the probe element.

Subsequent to its presentation by the lens, the image formed of the probe element makes possible a position or motion sensing of the probe element that is more precise than when no imaging lens system is used. Depending on the particular measuring task, the lens can compensate for or modify the numerical aperture. It can adapt the imaging of the probe element to the available field of view.

If the diameter of the lens is smaller than the image diagonal of the optical sensor, it may be possible to track the motion of the lens itself on the image. When an image-processing system is used, the displacement of the probe element image out of the focal point can additionally be used to monitor the motion of the probe element.

In an embodiment, the lens is designed so that one or more optical structures that perform other optical functions are applied to the side edges or the lower face of the lens. These can include, for example, gratings, cross lines or concentric circles.

In an embodiment, the design of the lens can include at least one mirror surface at the lateral edge of the lens, within or on the surface thereof, to permit imaging of the surrounding area outside of the field of view of the lens.

In an embodiment, the lens can be used to compensate for the angle of view when an oblique view camera is used.

In an embodiment, the lens can be used to measure objects in media having optical densities that differ from air. A lens of this kind can be used, for example, to compensate for transitions in refractive index that occur during underwater measurements.

In an embodiment, the lens can be formed from two or more, for example, symmetrical parts which have a cut-out that can be used for enclosing the probe extension.

A device according to the present invention includes the following advantages.

Using a lens in accordance with the present invention can be more economical than changing the lens system in the camera. The lens may be mounted in a reversible process, allowing existing measurement systems to also be retrofitted therewith.

Given the same system optics, designed, for example, for a field of view of approximately 800 μm×600 μm in the context of a 10-fold magnification, the magnified probe element image can make it possible to more effectively capture the position or change in position and at a higher resolution. This can make the measurement system more sensitive, and can eliminate the execution of quasiquantized motion detection. The subpixeling routines required for precise measurements may therefore be used again for probe elements (spheres) having a diameter of less than 10 μm.

The sharpness of the image can be increased in connection with a lens having a reduced aperture. Potentially risky probing operations can therefore be recognized more effectively without the distance between the structure and the sensitive lens system of the camera having to be reduced.

The imaging fidelity can also be enhanced by using a lens having a reduced aperture. Shadow losses in the optical path can be reduced in this manner. This can likewise increase the accuracy of the measurement.

By using a lens that acts as a magnifier, a better determination can be made on the basis of the sensor field as to whether the probe element has effectively probed the wall of the object or whether what are known as stick-slip effects have resulted in a movement of the probe element. The switching cycle of a measuring probe may be ascertained by computing the optically captured contacting on the basis of the switch signal.

Higher-quality rough value measurements may be obtained by using smaller probe elements.

The need for using expensive, higher magnification lenses can be eliminated by using smaller probe elements. Moreover, when a high-precision, low-magnification optical system is used, performing the orientation on the measuring table can result in a simpler process which is of further benefit to the user.

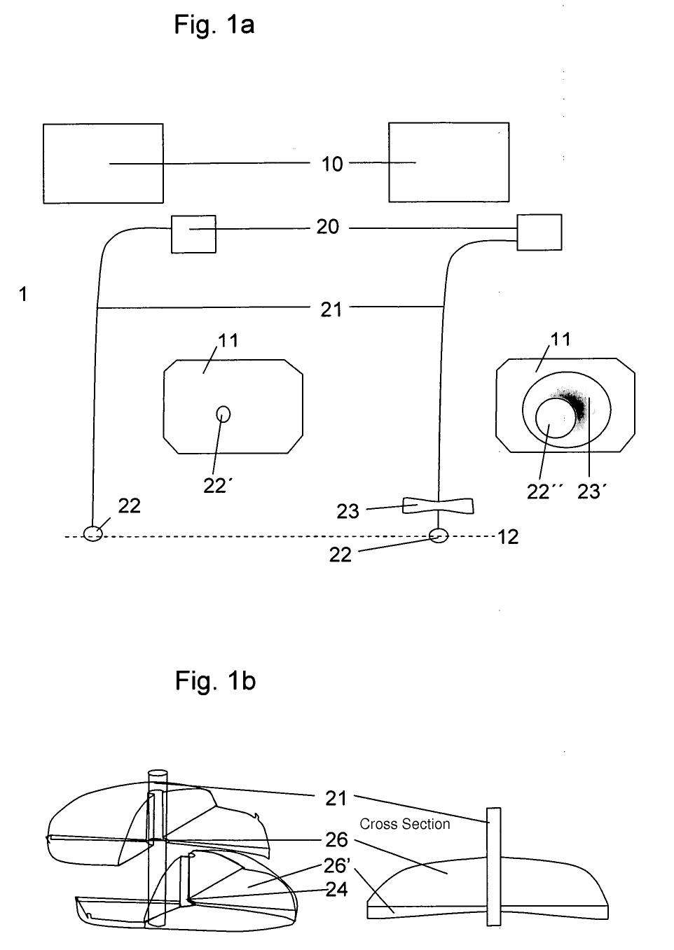

FIG. 1A shows schematically a prior art device (on the left) and a device according to the present invention (on the right), including the image of the probe element imaged on the sensor field. An approximately spherical probe element 22 is respectively affixed in each case to the tip of a probe extension 21, which can be secured to a probe element suspension 20. In the first device, the illuminated probe element 22, which is, for example, located in plane 12 of the focus of the optical sensor (camera focus), results in an image 22′ of probe element 22 within image 11 of the optical sensor (camera image). In an embodiment of the present invention, a lens 23 can be mounted above plane 12 of the optical sensor focus (camera focus) so that, within image 11 of the optical sensor (camera image), image 22′ of probe element 22, which can be magnified in comparison to the state of the art, can be produced within image 23′ of the lens.

FIG. 1B shows an embodiment of the design of lens 23. Lens 23′ can be assembled from two injection-molded symmetrical parts 26, 26′, which can enclose probe extension 21 in the region of cut-out 24.

FIG. 2 shows an embodiment of the device. A spherical probe element 22 can be affixed at the tip of a probe extension 21. Probe extension 21 can also be provided with a holding fixture 30, which can include mechanical connections 37, 37′, 37″ on three sides, which can support a lens 23 that can have a cut-out 24 for probe extension 21. Image 22′ of probe element 22 imaged onto lens 23 shows the magnification effect of the lens.

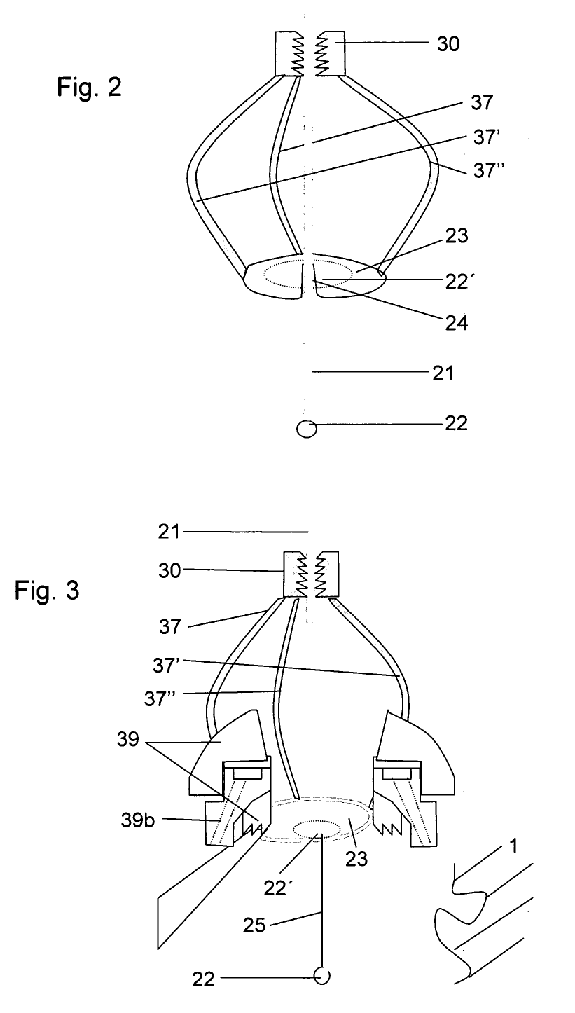

FIG. 3 shows an embodiment of the invention. Probe extension 21 can be provided with a holding fixture 30, whose optical plane resides above the focus of the optical sensor. Holding fixture 30 can have one or more mechanical connections 37, 37′, 37″ on which light-collecting elements 31, 31′ can be mounted, respectively, as supplementary elements 39 in a first optical plane. The supplementary elements 39 can also include light focusing elements and air channels. The air channels can each be connected with a compressed air supply. The light collected by the light-collecting element 31 can be projected via a light-focusing element onto a wall 1 of the object so that probe element 22 can be effectively illuminated. The spherical probe element 22 can be mounted on a secondary probe extension 25, which, due to the cut-out of probe extension 21 between holding fixture 30 and lens 23, can be provided between lens 23 and probe element 22. The image 22′ of probe element 22 imaged onto lens 23 shows the magnification effect of the lens.

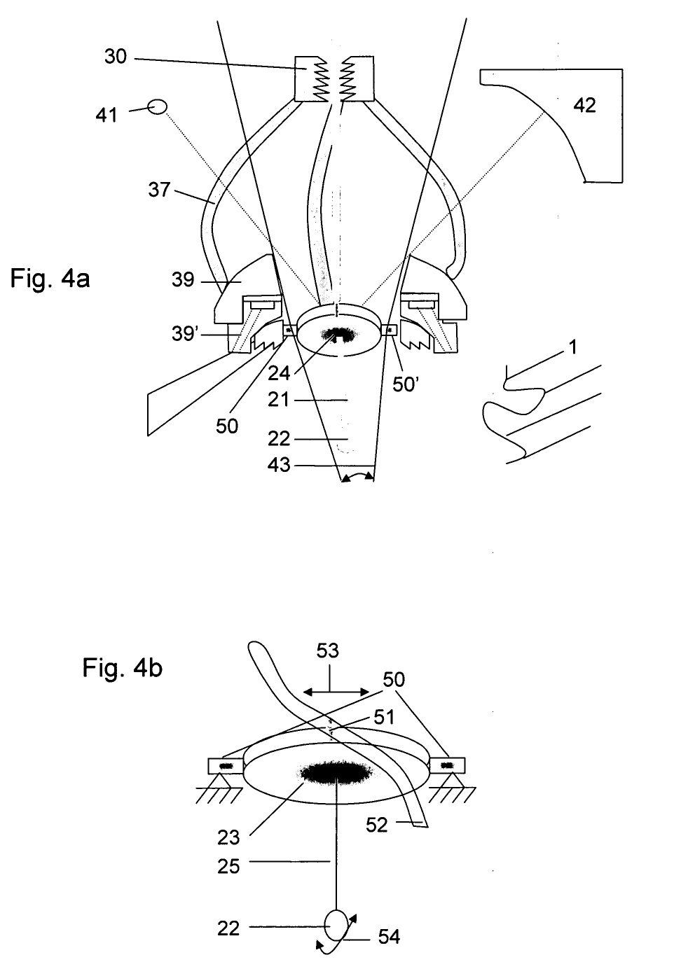

FIG. 4A shows an embodiment of a passive device including lens 23 and holding fixture 30, which differs from the device shown in FIG. 3 in that the probe extension 21 is not interrupted and lens 23 is additionally provided with a mounting support 50, 50′ which imparts rotational degrees of freedom to the lens. A tilt sensor 42, which receives the light generated by light source 41 and reflected off of lens 23, can detect the deflection of lens 23 and ascertain the tilt thereof. This device does not necessarily require restoring moments because a displacement of probe element 22 within aperture-dependent image detail 43 may be visible whether probe extension 21 is rigid or flexible. Due to the finite diameter of probe extension 21, which is located in its optical axis, lens 23 has an optically ineffective center.

FIG. 4B shows an embodiment where the deflection of probe element 22 may be induced. A slotted lever can impart rotation to the lens about a horizontal axis through the center thereof.

This may also be repeated for axes having different orientations to achieve a plurality of degrees of freedom. The movement 53 induced by force transmission 51 to produce the deflection ultimately effects a resulting movement 54 of probe element 22.

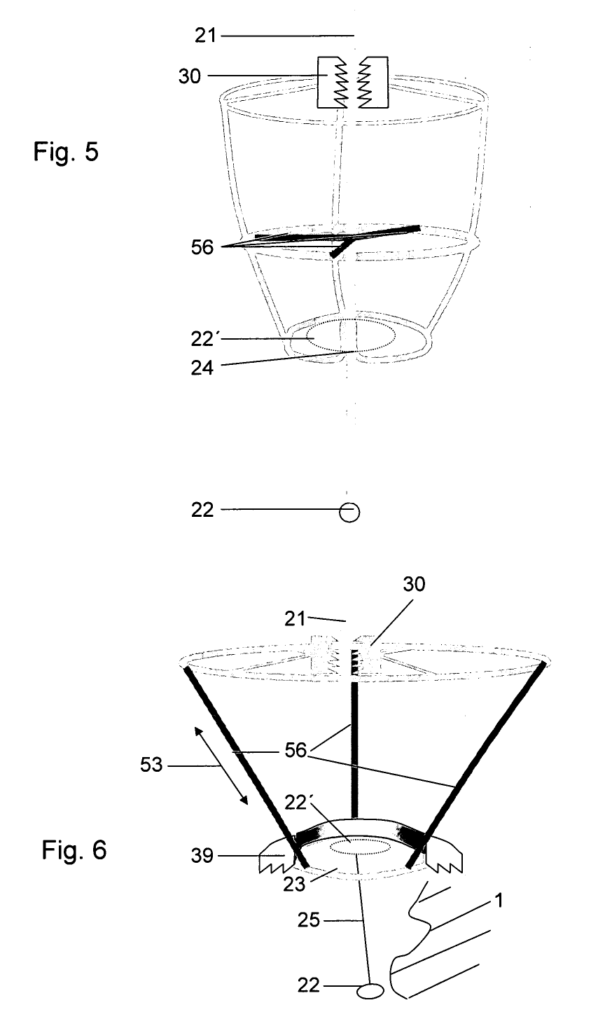

FIG. 5 shows an embodiment where the lens 23 is actively deflected. Lens 23 can be moved via piezorods 56 within a fixed optical axis.

FIG. 6 shows an embodiment where the lens 23 is actively deflected via piezorods 56. The piezorods 56 can be disposed in a tripod configuration having a movable optical axis.

1-16. (canceled)

17. A device for measuring structures of an object, the device comprising:
a probe element extending from a probe extension;
an optical sensor for capturing an image of the probe element on a sensor field;
an evaluation unit configured to compute the structures based on a position of the optical sensor relative to a coordinate system of a coordinate measuring machine and from a position of the probe element measured by the optical sensor; and
a lens disposed on the probe extension between the optical sensor and the probe element.

18. The device as recited in claim 17, wherein the lens is disposed at least partially outside a focus of the optical sensor.

19. The device as recited in claim 17, wherein the lens is disposed approximately radially symmetrical to the probe extension.

20. The device as recited in claim 17, wherein a radius of curvature of a side of the lens facing the probe element is greater than a radius of curvature of a side of the lens facing away from the probe element.

21. The device as recited in claim 17, wherein the lens includes two or more parts.

22. The device as recited in claim 17, wherein the lens includes optical structures.

23. The device as recited in claim 17, further comprising a holding fixture disposed on the probe extension.

24. The device as recited in claim 23, wherein the probe extension is interrupted in a section between the holding fixture and the lens.

25. The device as recited in claim 23, wherein the holding fixture includes at least one connection.

26. The device as recited in claim 25, wherein the lens is connected to the at least one connection.

27. The device as recited in claim 25, further comprising at least one supplementary element disposed on the at least one connection.

28. The device as recited in claim 27, wherein the at least one supplementary element includes at least one of a light-collecting element and a light-focusing element.

29. The device as recited in claim 27, wherein the at least one supplementary element includes at least one air channel.

30. The device as recited in claim 29, wherein the at least one air channel is connected with a supply of compressed air.

31. The device as recited in claim 25, wherein the at least one connection includes at least one bearing, the lens being movable in at least one rotational degree of freedom via the at least one bearing.

32. The device as recited in claim 31, wherein the at least one connection includes at least three piezorods configured to control the movement of the lens.

33. The device as recited in claim 32, wherein the piezorods are configured as a tripod.
